(19) United States
(12) Patent Application Publication
(10) Pub. No.: US 2026/0045152 A1
(43) Pub. Date: Feb. 12, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TOSHIHIRO HIRAO, TOKYO (JP); RYU TATE, TOKYO (JP)

(21) Appl. No.: 19/102,617

(22) PCT Filed: Aug. 1, 2023
(86) PCT No.: PCT/JP2023/028066

§ 371 Date: Feb. 10, 2025

(30) Foreign Application Priority Data
Aug. 18, 2022 (JP) 2022-130572

(51) Int. Cl. G08B 7/00; B60Q 9/00

(52) U.S. Cl. CPC G08B 7/00; B60Q 9/00

(57) ABSTRACT

The present technology relates to an information processing apparatus, an information processing method, and a program that enable improving the effectiveness of alerts.

The information processing apparatus includes an alert event detection unit configured to detect an alert event that is an event for which an alert is output, an alert control condition detection unit configured to detect an alert control condition that is a condition for controlling an output method for the alert, and an alert control unit configured to control the output method for the alert for the alert event on the basis of the alert control condition. The present technology can be applied to vehicles, for example.

### TECHNICAL FIELD

The present technology relates to an information processing apparatus, an information processing method, and a program, and in particular, to an information processing apparatus, an information processing method, and a program suitable for use in a case where alerts are output.

### BACKGROUND ART

Hitherto, in a vehicle, in a case where an emergency occurs, alerts are output by voice or the like (see, for example, PTL 1).

Further, in recent years, warning systems have been diversified along with advancement of vehicles. For example, systems configured to provide alerts, such as proximity warnings for advanced driver assistance systems, driver visibility warnings, and route guidance, have been installed in vehicles.

### CITATION LIST

### Patent Literature

### [PTL 1]

Japanese Patent Laid-open No. 2022-35024

### SUMMARY

### Technical Problem

However, as warning systems are diversified and types of alerts are increased, there is a risk that it becomes difficult for drivers to recognize reasons why alerts have been output. Further, as the types of alerts are increased and the output frequency of alerts is increased, trust of drivers in alerts is decreased. Therefore, there is a concern that drivers do not follow alerts in emergency situations.

The present technology has been made in view of such circumstances and improves effectiveness of alerts.

### Solution to Problem

An information processing apparatus of an aspect of the present technology includes an alert event detection unit configured to detect an alert event that is an event for which an alert is output, an alert control condition detection unit configured to detect an alert control condition that is a condition for controlling an output method for the alert, and an alert control unit configured to control the output method for the alert for the alert event on the basis of the alert control condition.

An information processing method of an aspect of the present technology includes, by an information processing apparatus, detecting an alert event that is an event for which an alert is output, detecting an alert control condition that is a condition for controlling an output method for the alert, and controlling the output method for the alert for the alert event on the basis of the alert control condition.

A program of an aspect of the present technology causes a computer to execute processing of detecting an alert event that is an event for which an alert is output, detecting an alert control condition that is a condition for controlling an output method for the alert, and controlling the output method for the alert for the alert event on the basis of the alert control condition.

In an aspect of the present technology, an alert event that is an event for which an alert is output is detected, an alert control condition that is a condition for controlling an output method for the alert is detected, and the output method for the alert for the alert event is controlled on the basis of the alert control condition.

### BRIEF DESCRIPTION OF DRAWINGS

FIG. 1 is a block diagram illustrating a configuration example of a vehicle control system.

FIG. 2 is a view illustrating examples of sensing areas.

FIG. 3 is a block diagram illustrating a configuration example of an alert processing unit.

FIG. 4 is a view illustrating a configuration example of a display forming a display system of a vehicle.

FIG. 5 is a view illustrating a configuration example of a loop light.

FIG. 6 is a flowchart illustrating alert output control processing.

FIG. 7 is a diagram illustrating a calculation method for reference scores.

FIG. 8 is a diagram illustrating output levels and output methods for alerts.

FIG. 9 is a diagram illustrating an example of an output method for alerts.

FIG. 10 is a block diagram illustrating a configuration example of a computer.

### DESCRIPTION OF EMBODIMENT

In the following, an embodiment of the present technology is described. The descriptions are made in the following order.
1. Configuration Example of Vehicle Control System
2. Embodiment
3. Modified Examples
4. Others

### 1. Configuration Example of Vehicle Control System

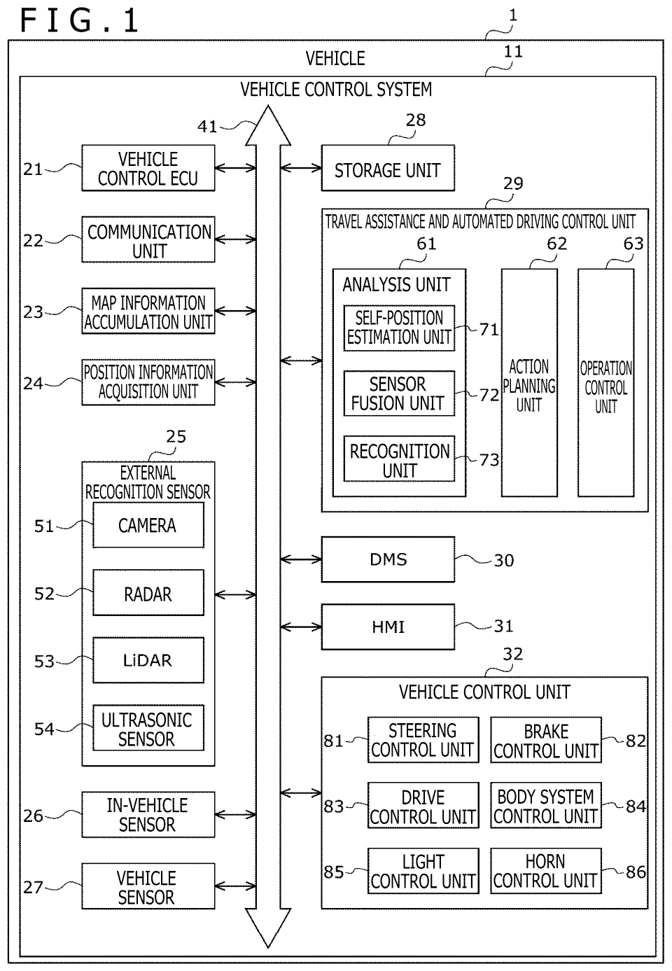

FIG. 1 is a block diagram illustrating a configuration example of a vehicle control system 11 as an example of a mobile apparatus control system to which the present technology is applied.

The vehicle control system 11 is provided in a vehicle 1 and performs processing related to the travel assistance and automated driving of the vehicle 1.

The vehicle control system 11 includes a vehicle control ECU (Electronic Control Unit) 21, a communication unit 22, a map information accumulation unit 23, a position information acquisition unit 24, an external recognition sensor 25, an in-vehicle sensor 26, a vehicle sensor 27, a storage unit 28, a travel assistance and automated driving control unit 29, a DMS (Driver Monitoring System) 30, an HMI (Human Machine Interface) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance and automated driving control unit 29, the driver monitoring system (DMS) 30, the human machine interface (HMI) 31, and the vehicle control unit 32 are communicably connected to each other via a communication network 41. The communication network 41 includes, for example, an on-vehicle communication network or a bus that conform to digital bidirectional communication standards, such as a CAN (Controller Area Network), a LIN (Local Interconnect Network), a LAN (Local Area Network), a FlexRay (registered trademark), or an Ethernet (registered trademark). The communication network 41 may be differentiated depending on the types of data to be transmitted. For example, CAN may be applied for data related to vehicle control, while the Ethernet may be applied for large-capacity data. Note that, in some cases, each unit of the vehicle control system 11 is directly connected without the communication network 41 using wireless communication intended for relatively short-range communication, such as near field communication (NFC) or Bluetooth (registered trademark).

Note that, in the following, in a case where each unit of the vehicle control system 11 performs communication via the communication network 41, the description of the communication network 41 is omitted. For example, in a case where the vehicle control ECU 21 communicates with the communication unit 22 via the communication network 41, such a case is simply described as “the vehicle control ECU 21 communicates with the communication unit 22.”

The vehicle control ECU 21 includes, for example, various processors such as a CPU (Central Processing Unit) and an MPU (Micro Processing Unit). The vehicle control ECU 21 controls all or some of the functions of the vehicle control system 11.

The communication unit 22 communicates with various types of equipment inside and outside the vehicle, other vehicles, servers, base stations, and the like, and transmits and receives various types of data. At this time, the communication unit 22 can perform communication using multiple communication methods.

The communication with the outside of the vehicle that the communication unit 22 can execute is generally described. The communication unit 22 communicates with, for example, servers existing on external networks (hereinafter referred to as external servers) via base stations or access points using wireless communication methods such as 5G (5th generation mobile communication system), LTE (Long Term Evolution), or DSRC (Dedicated Short Range Communications). The external networks with which the communication unit 22 communicates are, for example, the Internet, cloud networks, company-specific networks, or the like. The communication method that the communication unit 22 performs with respect to the external networks is not particularly limited as long as it is a wireless communication method capable of digital bidirectional communication at a predetermined communication speed or higher and over a predetermined distance or longer.

Further, for example, the communication unit 22 can communicate with terminals existing in the vicinity of the subject vehicle using P2P (Peer To Peer) technology. The terminals existing in the vicinity of the subject vehicle are, for example, terminals worn by mobile bodies moving at relatively low speeds, such as pedestrians and bicycles, terminals installed at fixed positions such as stores, or MTC (Machine Type Communication) terminals. Moreover, the communication unit 22 can also perform V2X communication. V2X communication refers to communication between the subject vehicle and others, such as vehicle-to-vehicle communication with other vehicles, vehicle-to-infrastructure communication with roadside units or the like, vehicle-to-home communication with homes, and vehicle-to-pedestrian communication with terminals or the like possessed by pedestrians.

The communication unit 22 can receive, for example, programs for updating software for controlling the operation of the vehicle control system 11 from the outside (Over The Air). The communication unit 22 can also receive map information, traffic information, information regarding surroundings of the vehicle 1, and the like from the outside. Further, for example, the communication unit 22 can transmit information associated with the vehicle 1, information regarding surroundings of the vehicle 1, and the like to the outside. Examples of the information associated with the vehicle 1 that the communication unit 22 transmits to the outside include data indicating the state of the vehicle 1 and recognition results by a recognition unit 73. Moreover, for example, the communication unit 22 performs communication corresponding to vehicle emergency call systems such as eCall.

For example, the communication unit 22 receives electromagnetic waves transmitted by the Vehicle Information and Communication System (VICS) (registered trademark), such as radio wave beacons, optical beacons, or FM multiplex broadcasting.

The communication with the inside of the vehicle that the communication unit 22 can execute is generally described. The communication unit 22 can communicate with each piece of equipment inside the vehicle using, for example, wireless communication. The communication unit 22 can wirelessly communicate with equipment inside the vehicle using, for example, communication methods capable of digital bidirectional communication at a predetermined communication speed or higher via wireless communication, such as wireless a LAN, Bluetooth, NFC, or WUSB (Wireless USB). The communication unit 22 is not limited to this and can also communicate with each piece of equipment inside the vehicle using wired communication. For example, the communication unit 22 can communicate with each piece of equipment inside the vehicle via wired communication through cables connected to connection terminals, which are not illustrated. The communication unit 22 can communicate with each piece of equipment inside the vehicle using, for example, communication methods capable of digital bidirectional communication at a predetermined communication speed or higher via wired communication, such as USB (Universal Serial Bus), HDMI (High-Definition Multimedia Interface) (registered trademark), or MHL (Mobile High-definition Link).

Here, equipment inside the vehicle refers to, for example, equipment not connected to the communication network 41 inside the vehicle. As the equipment inside the vehicle, for example, mobile equipment or wearable equipment possessed by the occupant such as a driver, information equipment brought into the vehicle and temporarily installed, or the like is assumed.

The map information accumulation unit 23 accumulates either or both maps acquired from the outside and maps created in the vehicle 1. For example, the map information accumulation unit 23 accumulates three-dimensional high-precision maps, global maps that cover wider areas with lower precision than high-precision maps, and the like.

The high-precision maps are, for example, dynamic maps, point cloud maps, vector maps, or the like. A dynamic map is, for example, a map including four layers of dynamic information, semi-dynamic information, semi-static information, and static information, and is provided from an external server or the like to the vehicle 1. A point cloud map is a map including point clouds (point cloud data). A vector map is, for example, a map in which traffic information such as lane and traffic light positions and a point cloud map are associated and adapted for ADAS (Advanced Driver Assistance System) or AD (Automated driving).

For example, the point cloud maps and the vector maps may be provided from external servers or the like or may be created in the vehicle 1 and accumulated in the map information accumulation unit 23 as maps for matching with local maps, which are described later, on the basis of sensing results by a camera 51, a radar 52, a LiDAR 53, or the like. Further, in a case where a high-precision map is provided from an external server or the like, in order to reduce communication capacity, for example, map data regarding several hundred meters square related to a planned route on which the vehicle 1 is to travel from now on is acquired from the external server or the like.

The position information acquisition unit 24 receives GNSS (Global Navigation Satellite System) signals from GNSS satellites and acquires position information regarding the vehicle 1. The acquired position information is supplied to the travel assistance and automated driving control unit 29. Note that the position information acquisition unit 24 is not limited to methods using GNSS signals and may acquire position information using beacons, for example.

The external recognition sensor 25 includes various sensors used for recognizing the external situation of the vehicle 1 and supplies sensor data from each sensor to the respective units of the vehicle control system 11. The external recognition sensor 25 includes any type and number of sensors.

For example, the external recognition sensor 25 includes the camera 51, the radar 52, the LiDAR (Light Detection and Ranging, Laser Imaging Detection and Ranging) 53, and an ultrasonic sensor 54. The external recognition sensor 25 is not limited to this and may include one or more types of sensors among the camera 51, the radar 52, the LiDAR 53, and the ultrasonic sensor 54. The numbers of the cameras 51, the radars 52, the LiDARs 53, and the ultrasonic sensors 54 are not particularly limited as long as the camera 51, the radar 52, the LiDAR 53, and the ultrasonic sensor 54 can realistically be installed in the vehicle 1. Further, the types of sensors included in the external recognition sensor 25 are not limited to this example, and the external recognition sensor 25 may include other types of sensors. Examples of the sensing areas of each sensor included in the external recognition sensor 25 are described later.

Note that the imaging method of the camera 51 is not particularly limited. For example, a camera using an imaging method of any kind capable of distance measurement, such as a ToF (Time Of Flight) camera, a stereo camera, a monocular camera, or an infrared camera, can be applied to the camera 51 as needed. The camera 51 is not limited to this and may be one for simply acquiring captured images regardless of distance measurement.

Further, for example, the external recognition sensor 25 can include an environmental sensor for detecting the environment around the vehicle 1. The environmental sensor is a sensor for detecting environment such as weather, atmospheric phenomena, and brightness. Examples of the environmental sensor can include various sensors such as raindrop sensors, fog sensors, sunlight sensors, snow sensors, and illuminance sensors.

Moreover, for example, the external recognition sensor 25 includes a microphone used for detecting the sound around the vehicle 1, the positions of sound sources, and the like.

The in-vehicle sensor 26 includes various sensors for detecting information regarding the inside of the vehicle and supplies sensor data from each sensor to the respective units of the vehicle control system 11. The types and numbers of the various sensors included in the in-vehicle sensor 26 are not particularly limited as long as the sensors can realistically be installed in the vehicle 1.

For example, the in-vehicle sensor 26 can include one or more types of sensors including a camera, a radar, a seat sensor, a steering wheel sensor, a microphone, and a biosensor. As the camera included in the in-vehicle sensor 26, for example, a camera using an imaging method of any kind capable of distance measurement, such as a ToF camera, a stereo camera, a monocular camera, or an infrared camera, can be used. The camera included in the in-vehicle sensor 26 is not limited to this and may be one for simply acquiring captured images regardless of distance measurement. The biosensor included in the in-vehicle sensor 26 is provided on the seat, the steering wheel, or the like and detects various types of biometric information regarding the occupant such as a driver.

The vehicle sensor 27 includes various sensors for detecting the state of the vehicle 1 and supplies sensor data from each sensor to the respective units of the vehicle control system 11. The types and numbers of the various sensors included in the vehicle sensor 27 are not particularly limited as long as the sensors can realistically be installed in the vehicle 1.

For example, the vehicle sensor 27 includes a speed sensor, an acceleration sensor, an angular velocity sensor (gyro sensor), and an inertial measurement unit (IMU) that integrates them. For example, the vehicle sensor 27 includes a steering angle sensor configured to detect the steering angle of the steering wheel, a yaw rate sensor, an accelerator sensor configured to detect the operation amount of the accelerator pedal, and a brake sensor configured to detect the operation amount of the brake pedal. For example, the vehicle sensor 27 includes a rotation sensor configured to detect the number of rotations of the engine or the motor, an air pressure sensor configured to detect tire pressure, a slip ratio sensor configured to detect tire slip ratio, and a wheel speed sensor configured to detect the rotation speed of the wheels. For example, the vehicle sensor 27 includes a battery sensor configured to detect the remaining amount and temperature of the battery, and an impact sensor configured to detect external impact.

The storage unit 28 includes at least one of a non-volatile storage medium and a volatile storage medium, and stores data and programs. The storage unit 28 is used as, for example, EEPROM (Electrically Erasable Programmable Read Only Memory) and RAM (Random Access Memory), and as the storage media, magnetic storage devices such as HDDs (Hard Disc Drives), semiconductor storage devices, optical storage devices, and magneto-optical storage devices can be applied. The storage unit 28 stores various programs and data that each unit of the vehicle control system 11 uses. For example, the storage unit 28 includes an EDR (Event Data Recorder) and DSSAD (Data Storage System for Automated Driving), and stores information regarding the vehicle 1 before and after events such as accidents and information acquired by the in-vehicle sensor 26.

The travel assistance and automated driving control unit 29 controls the travel assistance and automated driving of the vehicle 1. For example, the travel assistance and automated driving control unit 29 includes an analysis unit 61, an action planning unit 62, and an operation control unit 63.

The analysis unit 61 performs the analysis processing of the vehicle 1 and the situation around the vehicle 1. The analysis unit 61 includes a self-position estimation unit 71, a sensor fusion unit 72, and the recognition unit 73.

The self-position estimation unit 71 estimates the self-position of the vehicle 1 on the basis of sensor data from the external recognition sensor 25 and a high-precision map accumulated in the map information accumulation unit 23. For example, the self-position estimation unit 71 generates a local map on the basis of sensor data from the external recognition sensor 25 and matches the local map with a high-precision map, thereby estimating the self-position of the vehicle 1. The reference of the position of the vehicle 1 is, for example, the center of the rear wheel pair axle.

The local map is, for example, a three-dimensional high-precision map created using a technology such as SLAM (Simultaneous Localization and Mapping) or an occupancy grid map. The three-dimensional high-precision map is, for example, a point cloud map as described above. The occupancy grid map is a map that divides the three-dimensional or two-dimensional space around the vehicle 1 into grids (lattices) of a predetermined size and indicates the occupied state of an object in grid units. The occupied state of an object is indicated by, for example, the presence or absence or existence probability of the object. The local map is also used for, for example, the detection processing and recognition processing of the external situation of the vehicle 1 by the recognition unit 73.

Note that the self-position estimation unit 71 may estimate the self-position of the vehicle 1 on the basis of position information acquired by the position information acquisition unit 24 and sensor data from the vehicle sensor 27.

The sensor fusion unit 72 performs the sensor fusion processing of combining multiple different types of sensor data (for example, image data supplied from the camera 51 and sensor data supplied from the radar 52), thereby obtaining new information. Examples of the method of combining different types of sensor data include integration, fusion, and association.

The recognition unit 73 executes the detection processing of detecting the external situation of the vehicle 1 and the recognition processing of recognizing the external situation of the vehicle 1.

For example, the recognition unit 73 performs the detection processing and recognition processing of the external situation of the vehicle 1 on the basis of information from the external recognition sensor 25, information from the self-position estimation unit 71, information from the sensor fusion unit 72, and the like.

Specifically, for example, the recognition unit 73 performs the detection processing, the recognition processing, and the like of objects around the vehicle 1. Object detection processing refers to, for example, the processing of detecting the presence or absence, sizes, shapes, positions, movement, and the like of objects. Object recognition processing refers to, for example, the processing of recognizing attributes such as the types of objects or of identifying specific objects. However, the detection processing and the recognition processing are not necessarily clearly separated and overlap in some cases.

For example, the recognition unit 73 performs clustering to classify point clouds based on sensor data from the radar 52, the LiDAR 53, or the like into clusters of points, thereby detecting objects around the vehicle 1. With this, the presence or absence, sizes, shapes, and positions of objects around the vehicle 1 are detected.

For example, the recognition unit 73 performs tracking to follow the movement of clusters of points classified by clustering, thereby detecting the movement of objects around the vehicle 1. With this, the speed and directions of travel (movement vectors) of objects around the vehicle 1 are detected.

For example, the recognition unit 73 detects or recognizes vehicles, people, bicycles, obstacles, structures, roads, traffic lights, traffic signs, road markings, and the like on the basis of image data supplied from the camera 51. Further, the recognition unit 73 may perform recognition processing such as semantic segmentation to recognize the types of objects around the vehicle 1.

For example, the recognition unit 73 can perform the recognition processing of traffic rules around the vehicle 1 on the basis of maps accumulated in the map information accumulation unit 23, the estimation results of self-position by the self-position estimation unit 71, and the recognition results of objects around the vehicle 1 by the recognition unit 73. Through this processing, the recognition unit 73 can recognize the positions and states of traffic lights, the content of traffic signs and road markings, the content of traffic regulations, drivable lanes, and the like.

For example, the recognition unit 73 can perform the recognition processing of the environment around the vehicle 1. As the surrounding environment that the recognition unit 73 recognizes, weather, temperature, humidity, brightness, road surface conditions, and the like are assumed.

The action planning unit 62 creates action plans for the vehicle 1. For example, the action planning unit 62 performs route planning and route following processing to create action plans.

Note that route planning (Global path planning) refers to the processing of planning a rough route from start to goal. This route planning also includes generally-called trajectory planning, which is the processing of generating, considering the motion characteristics of the vehicle 1, a trajectory on the planned route that allows for safe and smooth driving in the vicinity of the vehicle 1 (Local path planning).

Route following refers to the processing of planning operations to drive safely and accurately along a route planned by route planning within the planned time. On the basis of the result of this route following processing, for example, the action planning unit 62 can calculate the target speed and target angular velocity of the vehicle 1.

The operation control unit 63 controls the operation of the vehicle 1 to achieve action plans created by the action planning unit 62.

For example, the operation control unit 63 controls a steering control unit 81, a brake control unit 82, and a drive control unit 83 included in the vehicle control unit 32, which are described later, to perform acceleration/deceleration control and direction control such that the vehicle 1 travels along a trajectory calculated by trajectory planning. For example, the operation control unit 63 performs cooperative control for the purpose of achieving ADAS functions such as collision avoidance or impact mitigation, following driving, speed maintenance driving, collision warning for the subject vehicle, and lane departure warning for the subject vehicle. For example, the operation control unit 63 performs cooperative control for the purpose of, for example, automated driving, which allows the vehicle to autonomously travel independently of the operation of the driver.

The DMS 30 performs the authentication processing of the driver, the recognition processing of the state of the driver, and the like on the basis of sensor data from the in-vehicle sensor 26, input data input to the HMI 31, which is described later, and the like. As the state of the driver to be recognized, for example, physical condition, alertness level, concentration level, fatigue level, line-of-sight direction, drunkenness level, driving operation, posture, and the like are assumed.

Note that the DMS 30 may perform the authentication processing of an occupant other than the driver and the recognition processing of the state of the occupant in question. Further, for example, the DMS 30 may perform the recognition processing of the situation inside the vehicle on the basis of sensor data from the in-vehicle sensor 26. As the situation inside the vehicle to be recognized, for example, temperature, humidity, brightness, odor, and the like are assumed.

The HMI 31 performs the input of various types of data, instructions, and the like, and the presentation of various types of data to the driver and the like.

The input of data by the HMI 31 is generally described. The HMI 31 includes input devices for people to input data. The HMI 31 generates input signals on the basis of data, instructions, and the like input by the input devices and supplies the input signals to each unit of the vehicle control system 11. The HMI 31 includes, as input devices, operating elements such as a touch panel, a button, a switch, and a lever. The HMI 31 is not limited to this and may further include input devices that support the input of information by methods other than manual operation, such as voice or gestures. Moreover, the HMI 31 may use, for example, remote control apparatuses utilizing infrared or radio waves, or external connection equipment such as mobile equipment or wearable equipment compatible with the operation of the vehicle control system 11 as input devices.

The presentation of data by the HMI 31 is generally described. The HMI 31 generates visual information, auditory information, and tactile information regarding the occupant or the outside of the vehicle. Further, the HMI 31 performs the output control of controlling the output, the output content, the output timing, the output method, and the like of each piece of generated information. The HMI 31 generates and outputs, as visual information, for example, information indicated by images or lights, such as operation screens, the state display of the vehicle 1, warning displays, and monitor images indicating the situation around the vehicle 1. Further, the HMI 31 generates and outputs, as auditory information, for example, information indicated by sounds, such as voice guidance, warning sounds, and warning messages. Moreover, the HMI 31 generates and outputs, as tactile information, for example, information that is given to the sense of touch of the occupant through force, vibration, movement, or the like.

As the output device for the HMI 31 to output visual information, for example, a display apparatus configured to present visual information by displaying images by itself or a projector apparatus configured to present visual information by projecting images can be applied. Note that the display apparatus may be, other than a display apparatus having a normal display, for example, an apparatus configured to display visual information within the field of view of the occupant, such as a head-up display, a transmissive display, or a wearable device with AR (Augmented Reality) function. Further, the HMI 31 can also use a display device included in a navigation apparatus, an instrument panel, a CMS (Camera Monitoring System), an electronic mirror, lamps, or the like, which are provided in the vehicle 1, as an output device configured to output visual information.

As the output device for the HMI 31 to output auditory information, for example, an audio speaker, headphones, or earphones can be applied.

As the output device for the HMI 31 to output tactile information, for example, haptic elements using haptic technology can be applied. The haptic elements are provided in parts of the vehicle 1 with which the occupant comes into contact, such as the steering wheel and the seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 detects and controls the state of the steering system of the vehicle 1, for example. The steering system includes, for example, a steering mechanism including a steering wheel and the like, and electric power steering. The steering control unit 81 includes, for example, a steering ECU configured to control the steering system, an actuator configured to drive the steering system, and the like.

The brake control unit 82 detects and controls the state of the brake system of the vehicle 1, for example. The brake system includes, for example, a brake mechanism including a brake pedal and the like, an ABS (Antilock Brake System), and a regenerative brake mechanism. The brake control unit 82 includes, for example, a brake ECU configured to control the brake system, and an actuator configured to drive the brake system.

The drive control unit 83 detects and controls the state of the drive system of the vehicle 1, for example. The drive system includes, for example, an accelerator pedal, a drive force generation apparatus for generating drive force, such as an internal combustion engine or a drive motor, and a drive force transmission mechanism for transmitting drive force to the wheels. The drive control unit 83 includes, for example, a drive ECU configured to control the drive system, and an actuator configured to drive the drive system.

The body system control unit 84 detects and controls the state of the body-system system of the vehicle 1, for example. The body-system system includes, for example, a keyless entry system, a smart key system, a power window apparatus, power seats, an air conditioning apparatus, airbags, seatbelts, and a shift lever. The body system control unit 84 includes, for example, a body system ECU configured to control the body-system system, and an actuator configured to drive the body-system system.

The light control unit 85 detects and controls the states of the various lights of the vehicle 1, for example. As the lights to be controlled, for example, headlights, backlights, fog lights, turn signals, brake lights, projections, and bumper displays are assumed. The light control unit 85 includes a light ECU configured to control the lights, an actuator configured to drive the lights, and the like.

The horn control unit 86 detects and controls the state of the car horn of the vehicle 1, for example. The horn control unit 86 includes, for example, a horn ECU configured to control the car horn, and an actuator configured to drive the car horn.

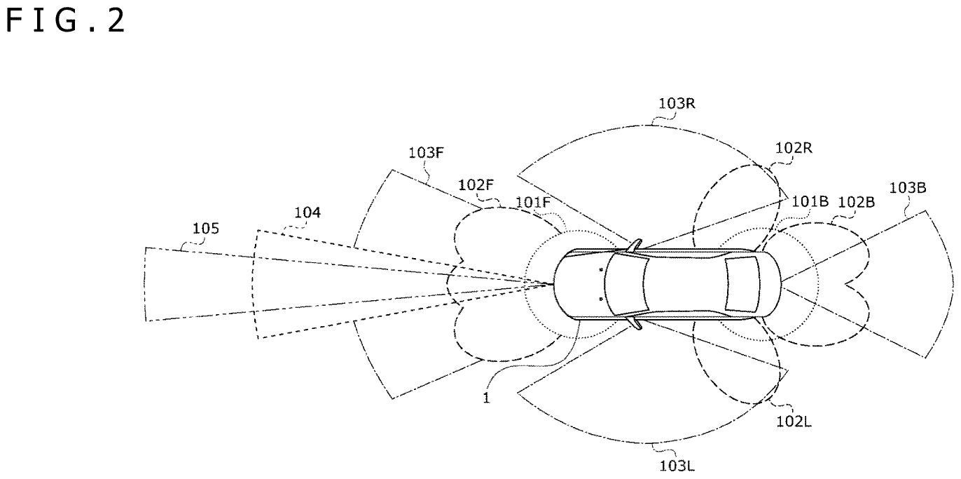

FIG. 2 is a view illustrating examples of the sensing areas of the camera 51, the radar 52, the LiDAR 53, the ultrasonic sensor 54, and the like of the external recognition sensor 25 in FIG. 1. Note that FIG. 2 schematically illustrates the vehicle 1 as viewed from above, with the left end side corresponding to the front end (front) side of the vehicle 1, and the right end side corresponding to the rear end (rear) side of the vehicle 1.

A sensing area 101F and a sensing area 101B indicate examples of the sensing area of the ultrasonic sensor 54. The sensing area 101F covers the area around the front end of the vehicle 1 by the multiple ultrasonic sensors 54. The sensing area 101B covers the area around the rear end of the vehicle 1 by the multiple ultrasonic sensors 54.

Sensing results in the sensing area 101F and the sensing area 101B are used for, for example, the parking assistance of the vehicle 1.

A sensing area 102F to a sensing area 102B indicate examples of the sensing area of the radar 52 for short range or medium range. The sensing area 102F covers farther positions than the sensing area 101F in front of the vehicle 1. The sensing area 102B covers farther positions than the sensing area 101B in rear of the vehicle 1. The sensing area 102L covers the area around the rear of the left-side surface of the vehicle 1. The sensing area 102R covers the area around the rear of the right-side surface of the vehicle 1.

Sensing results in the sensing area 102F are used for, for example, detecting vehicles, pedestrians, and the like located in front of the vehicle 1. Sensing results in the sensing area 102B are used for, for example, the function of preventing collision at the rear of the vehicle 1. Sensing results in the sensing area 102L and the sensing area 102R are used for, for example, detecting objects in blind spots on the lateral sides of the vehicle 1.

A sensing area 103F to a sensing area 103B indicate examples of the sensing area of the camera 51. The sensing area 103F covers farther positions than the sensing area 102F in front of the vehicle 1. The sensing area 103B covers farther positions than the sensing area 102B in rear of the vehicle 1. The sensing area 103L covers the area around the left-side surface of the vehicle 1. The sensing area 103R covers the area around the right-side surface of the vehicle 1.

Sensing results in the sensing area 103F can be used for, for example, the recognition of traffic lights and traffic signs, lane departure prevention assistance systems, and automatic headlight control systems. Sensing results in the sensing area 103B can be used for, for example, parking assistance and surround view systems. Sensing results in the sensing area 103L and the sensing area 103R can be used for, for example, surround view systems.

A sensing area 104 indicates an example of the sensing area of the LiDAR 53. The sensing area 104 covers farther positions than the sensing area 103F in front of the vehicle 1. On the other hand, the sensing area 104 has a narrower range in the left-right direction than the sensing area 103F.

Sensing results in the sensing area 104 are used for, for example, detecting objects such as surrounding vehicles.

A sensing area 105 indicates an example of the sensing area of the radar 52 for long range. The sensing area 105 covers farther positions than the sensing area 104 in front of the vehicle 1. On the other hand, the sensing area 105 has a narrower range in the left-right direction than the sensing area 104.

Sensing results in the sensing area 105 are used for, for example, ACC (Adaptive Cruise Control), emergency braking, and collision avoidance.

Note that the sensing areas of each sensor, including the camera 51, the radar 52, the LiDAR 53, and the ultrasonic sensor 54, which are included in the external recognition sensor 25, may have various configurations other than those in FIG. 2. Specifically, the ultrasonic sensor 54 may also sense the lateral sides of the vehicle 1, and the LiDAR 53 may sense the rear of the vehicle 1. Further, the installation positions of each sensor are not limited to the respective examples described above. Further, the number of each sensor may be one or plural.

### 2. Embodiment

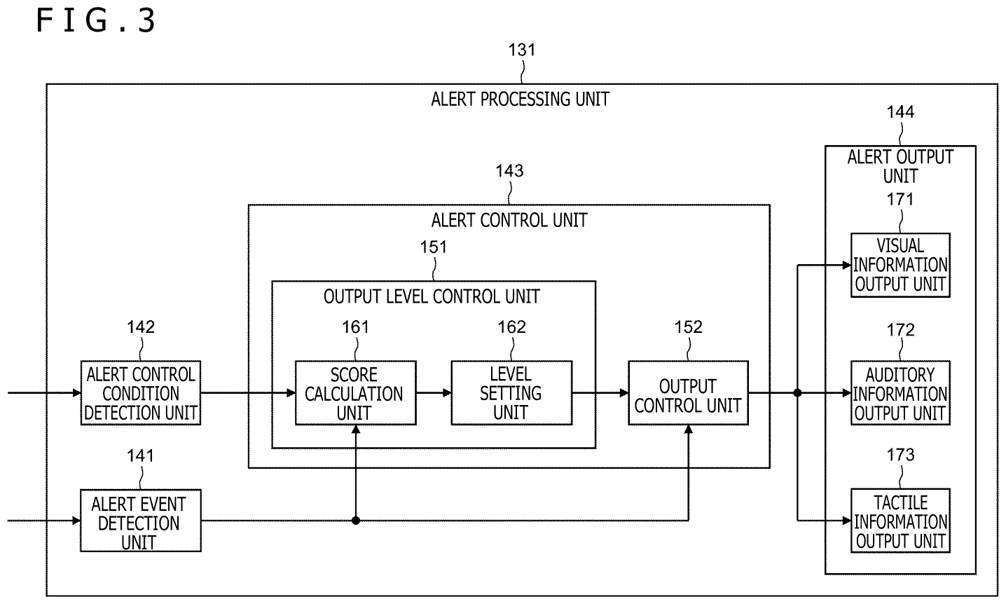

Next, with reference to FIG. 3 to FIG. 9, the embodiment of the present technology is described.

### Detailed Configuration Example of Alert Processing Unit 131

FIG. 3 illustrates a configuration example of an alert processing unit 131 of the vehicle 1 in FIG. 1.

The alert processing unit 131 forms parts of, for example, the DMS 30, the HMI 31, and the recognition unit 73 of the vehicle 1. The alert processing unit 131 is a part configured to execute the processing of outputting alerts to the occupant such as a driver in the vehicle 1.

The alert processing unit 131 includes an alert event detection unit 141, an alert control condition detection unit 142, an alert control unit 143, and an alert output unit 144.

The alert event detection unit 141 executes the detection processing of events for which alerts are output (hereinafter referred to as alert events) on the basis of at least one of the situation around the vehicle 1, the situation inside the vehicle 1, the state of the vehicle 1, and the state of the occupant including the driver. The alert events are, for example, events which need to be warned to the occupant of the vehicle 1 or which the occupant of the vehicle 1 need to be notified of.

For example, the alert event detection unit 141 executes the detection processing of alert events on the basis of information obtained with the communication unit 22 communicating with various types of equipment outside the vehicle, other vehicles, servers, base stations, or the like, the external situation of the vehicle 1 recognized or detected by the recognition unit 73, the state of the occupant and the situation inside the vehicle recognized by the DMS 30, the state of each unit of the vehicle 1 detected by the respective units of the vehicle control unit 32, and the like. The alert event detection unit 141 supplies alert event detection information indicating the detection results of alert events to the score calculation unit 161 and the output control unit 152.

The alert control condition detection unit 142 executes the detection processing of conditions for controlling the output methods for alerts (hereinafter referred to as alert control conditions) on the basis of at least one of the situation around the vehicle 1, the situation inside the vehicle 1, the state of the vehicle 1, and the state of the occupant. The alert control conditions are, for example, conditions independent of alert events, in other words, conditions based on events different from alert events.

For example, the alert control condition detection unit 142 executes the detection processing of alert control conditions on the basis of information obtained with the communication unit 22 communicating with various types of equipment outside the vehicle, other vehicles, servers, base stations, or the like, the external situation of the vehicle 1 recognized or detected by the recognition unit 73, the state of the occupant and the situation inside the vehicle recognized by the DMS 30, the state of each unit of the vehicle 1 detected by the respective units of the vehicle control unit 32, and the like. The alert control condition detection unit 142 supplies alert control condition detection information indicating the detection results of alert control conditions to the score calculation unit 161.

The alert control unit 143 controls the output of alerts by the alert output unit 144. For example, the alert control unit 143 controls the output timing, the output methods, the output content, and the like of alerts. The alert control unit 143 includes an output level control unit 151 and an output control unit 152.

The output level control unit 151 controls the output levels of alerts for detected alert events. The output level control unit 151 includes a score calculation unit 161 and a level setting unit 162.

The score calculation unit 161 calculates reference scores indicating the necessity of alerts on the basis of the detection results of alert events and alert control conditions. The score calculation unit 161 notifies the level setting unit 162 of the calculation results of reference scores.

The level setting unit 162 sets the output levels of alerts on the basis of reference scores. Here, since a reference score indicates the necessity of an alert, the output level of the alert is set on the basis of the necessity of the alert. The level setting unit 162 notifies the output control unit 152 of the set output levels.

The output control unit 152 controls the output timing, the output content, the output methods, and the like of alerts by the alert output unit 144 on the basis of the detection results of alert events and set output levels.

The alert output unit 144 executes the output processing of alerts. The alert output unit 144 includes a visual information output unit 171, an auditory information output unit 172, and a tactile information output unit 173.

The visual information output unit 171 includes an output device configured to output visual information. The visual information output unit 171 outputs alerts using visual information, such as images (moving images or still images), text messages, or light, under the control of the output control unit 152, for example.

The auditory information output unit 172 includes an output device configured to output tactile information. The auditory information output unit 172 outputs alerts using auditory information, such as music, voice messages, sirens, alarms, warning sounds, or sound effects, under the control of the output control unit 152, for example.

The tactile information output unit 173 includes an output device configured to output tactile information. The tactile information output unit 173 outputs alerts using tactile information, such as vibration or heat, under the control of the output control unit 152, for example.

### Configuration Examples of Displays Inside Vehicle

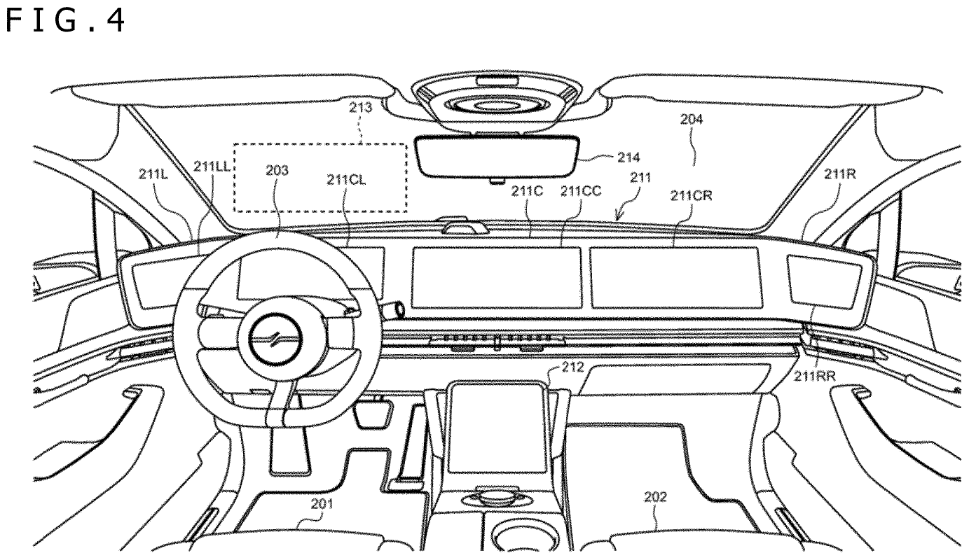

Next, with reference to FIG. 4, configuration examples of displays (display units) provided inside the vehicle 1, forming a part of the HMI 31, and forming the display system of the vehicle 1 are described. FIG. 4 is a schematic view illustrating the front of the vehicle interior.

Inside the vehicle, a center display 211, a console display 212, a head-up display (only a display 213 is illustrated), and a digital rear mirror 214 are provided.

The center display 211 is provided to extend left and right on the front surface of the dashboard in front of a driver's seat 201 and a passenger seat 202. The center display 211 is largely divided into a left end part 211L, a central part 211C, and a right end part 211R on the basis of the orientations of the displays. That is, the center display 211 has a configuration in which the left end part 211L, the central part 211C, and the right end part 211R, which have different orientations from each other, are continuous in the left-right direction and integrated. The left end part 211L, the central part 211C, and the right end part 211R can individually perform display independently of each other or can perform display integrally.

The central part 211C extends left and right from near the left end of the driver's seat 201 to near the right end of the passenger seat 202 in front of the driver's seat 201 and the passenger seat 202, and faces the rear (the rear of the vehicle 1) as viewed from the driver's seat 201 or the passenger seat 202. Further, the central part 211C faces slightly upward. With this, the angles of incidence of the lines of sight of the driver sitting in the driver's seat 201 and the occupant sitting in the passenger seat 202 when they look at the central part 211C become closer to vertical, thereby improving visibility.

The left end part 211L and the right end part 211R are provided approximately symmetrically at the respective left and right ends of the center display 211. The left end part 211L bends inward (toward the inside of the vehicle) at the left end of the center display 211 to form an angle in the vehicle interior direction relative to the central part 211C, and thus faces diagonally rearward to the right (diagonally rearward to the right of the vehicle 1) as viewed from the driver's seat 201 or the passenger seat 202. The right end part 211R bends inward (toward the inside of the vehicle) at the right end of the center display 211 to form an angle in the vehicle interior direction relative to the central part 211C, and thus faces diagonally rearward to the left (diagonally rearward to the left of the vehicle 1) as viewed from the driver's seat 201 or the passenger seat 202.

The angle of the left end part 211L relative to the central part 211C is adjusted such that, for example, the angle of reflection for the angle of incidence of a standard line of sight of the driver to the left end part 211L faces an appropriate diagonally rearward left direction of the vehicle 1. The angle of the right end part 211R relative to the central part 211C is adjusted such that, for example, the angle of reflection for the angle of incidence of the standard line of sight of the driver to the right end part 211R faces an appropriate diagonally rearward right direction of the vehicle 1.

The central part 211C of the center display 211 is divided into a display unit 211CL in front of a steering wheel 203 at the driver's seat 201, a display unit 211CC between the driver's seat 201 and the passenger seat 202, and a display unit 211CR in front of the passenger seat 202. Note that it is also possible to connect the display unit 211CL, the display unit 211CC, and the display unit 211CR to form a single display unit.

The central part 211C of the center display 211 displays, for example, information for assisting driving, images of surroundings of the vehicle 1, and infotainment-related information. For example, the display unit 211CL displays information mainly for the driver. For example, the display unit 211CC displays infotainment (in-vehicle infotainment) related information such as audio, video, websites, and maps. For example, the display unit 211CR displays infotainment-related information for the passenger seat occupant.

The left end part 211L of the center display 211 is provided with a display unit 211LL. The right end part 211R of the center display 211 is provided with a display unit 211RR.

The display unit 211LL and the display unit 211RR are mainly used as digital outer mirrors (electronic side mirrors) as alternatives to related-art side mirrors. That is, the display unit 211LL and the display unit 211RR are used for CMS. For example, the display unit 211LL displays images of the diagonally rearward left of the vehicle 1 captured by the camera 51. The display unit 211RR displays images of the diagonally rearward right of the vehicle 1 captured by the camera 51.

The console display 212 is provided on the console provided between the driver's seat 201 and the passenger seat 202, and is disposed below the central part 211C of the center display 211.

The console display 212 includes, for example, a two-dimensional or three-dimensional touch panel and can be operated by touching or bringing a finger or the like close to it. The console display 212 faces the rear of the vehicle 1. Further, the console display 212 faces diagonally upward at an approximately similar angle to the central part 211C of the center display 211. With this, a sense of unity as if the center display 211 and the console display 212 are seamlessly connected is created. Further, similar to the central part 211C of the center display 211, the visibility of the console display 212 is improved.

The console display 212 displays, for example, operation screens for operating information displayed on the center display 211, and operation screens for operating air conditioning equipment inside the vehicle.

The head-up display includes the display 213 (hereinafter referred to as the HUD display 213) provided in front of the driver's seat 201. For example, the HUD display 213 may include a part of a windshield 204 or may be provided separately from the windshield 204. In the latter case, for example, the HUD display 213 is attached to the windshield 204. Besides, visual information is projected onto the HUD display 213 using AR technology, thereby superimposing the visual information within the field of view of the driver.

The HUD display 213 displays, for example, information for assisting driving.

The digital rear mirror 214 is used instead of a related-art rearview mirror and is also called a smart room mirror. The digital rear mirror 214 is provided slightly in front of the upper edge and near the center of the windshield 204, similar to a related-art rearview mirror, and is disposed above the central part 211C of the center display 211.

The digital rear mirror 214 displays, for example, images of the rear of the vehicle 1 captured by the camera 51.

### Configuration Example of Loop Light 231

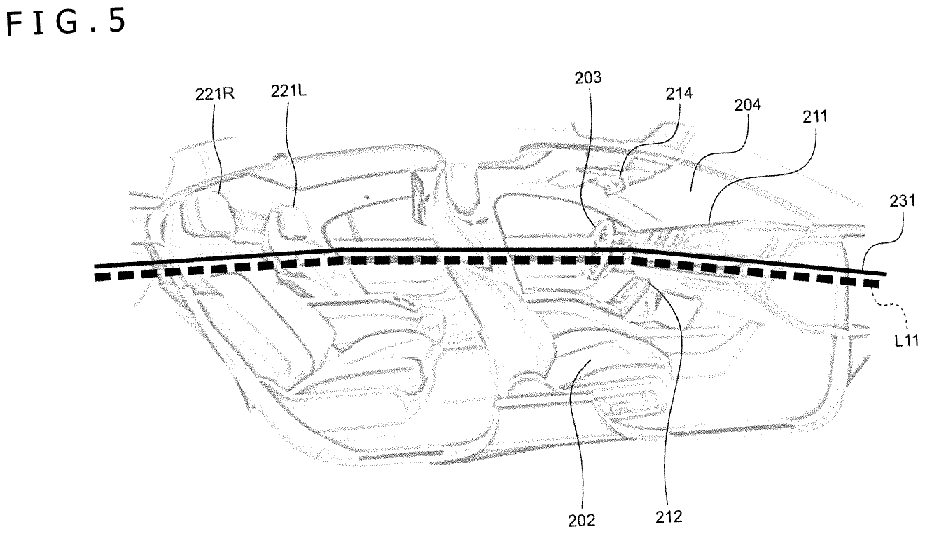

Next, with reference to FIG. 5, a loop light 231 provided inside the vehicle 1 is described.

FIG. 5 is a schematic view illustrating the interior of the vehicle 1 as viewed from the right direction.

Inside the vehicle 1, multiple user interface devices are arranged in a concentrated manner along a loop line L11, which is a virtual line surrounding the interior in an approximately horizontal direction, and various interfaces are consolidated.

Here, the user interface devices include, for example, output devices configured to output visual information, auditory information, and tactile information, and operation devices used for various operations. Further, being arranged along the loop line L11 includes not only the case of being arranged on the loop line L11 but also the case of being arranged in the vicinity of the loop line L11.

The loop line L11 is slightly inclined upward from front to rear. This is because the positions of a rear seat 221L and a rear seat 221R are higher than the positions of the driver's seat 201 and the passenger seat 202.

Besides, slightly above the loop line L11, the loop light 231 is disposed approximately in parallel with the loop line L11 to surround the vehicle interior. The loop light 231 is a downlight with multiple LEDs embedded to be arranged in an approximately horizontal direction inside the vehicle, and is mainly used as auxiliary lighting and interior decoration. Each LED can be individually controlled for on/off, color, brightness, and the like.

Note that the loop light 231 does not necessarily need to surround the entire vehicle interior and may be discontinuous and surround part of the vehicle interior.

### <Alert Output Control Processing>

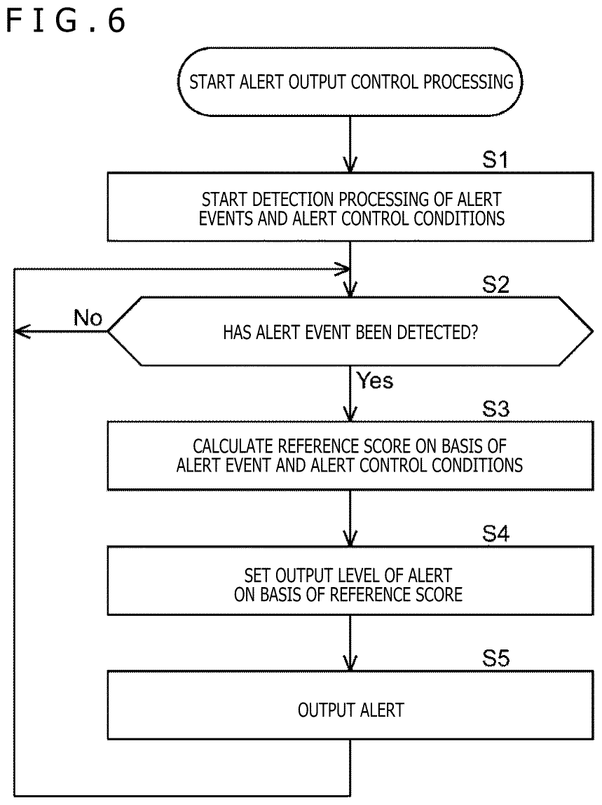

Next, with reference to the flowchart of FIG. 6, alert output control processing executed by the vehicle 1 is described.

This processing starts when the power of the vehicle 1 is turned on and ends when the power is turned off, for example.

In Step S1, the vehicle 1 starts the detection processing of alert events and alert control conditions.

For example, the alert event detection unit 141 starts the processing of detecting alert events on the basis of information obtained with the communication unit 22 communicating with various types of equipment outside the vehicle, other vehicles, servers, base stations, or the like, the external situation of the vehicle 1 recognized or detected by the recognition unit 73, the state of the occupant and the situation inside the vehicle recognized by the DMS 30, the state of each unit of the vehicle 1 detected by the respective units of the vehicle control unit 32, and the like.

Note that, for example, the alert event detection unit 141 can also detect alert events in blind spots from the vehicle 1 on the basis of information acquired from smart poles installed on roads via the communication unit 22. For example, the alert event detection unit 141 can detect the presence of other vehicles, bicycles, pedestrians, and the like in blind spots from the vehicle 1 as alert events. Further, for example, the alert event detection unit 141 can detect weather conditions (for example, temperature, humidity, and rain detection) as alert events on the basis of information acquired from smart poles installed on roads via the communication unit 22.

The alert event detection unit 141 starts the processing of supplying alert event detection information indicating the detection results of alert events to the score calculation unit 161 and the output control unit 152.

For example, the alert control condition detection unit 142 starts the processing of detecting alert control conditions on the basis of information obtained with the communication unit 22 communicating with various types of equipment outside the vehicle, other vehicles, servers, base stations, or the like, the external situation of the vehicle 1 recognized or detected by the recognition unit 73, the state of the occupant and the situation inside the vehicle recognized by the DMS 30, the state of each unit of the vehicle 1 detected by the respective units of the vehicle control unit 32, and the like. The alert control condition detection unit 142 starts the processing of supplying alert control condition detection information indicating the detection results of alert control conditions to the score calculation unit 161.

In Step S2, the score calculation unit 161 determines whether an alert event has been detected or not on the basis of the alert event information supplied from the alert event detection unit 141. This processing is repeatedly executed until it is determined that an alert event has been detected. Then, in a case where it is determined that an alert event has been detected, the processing proceeds to Step S3.

In Step S3, the score calculation unit 161 calculates a reference score on the basis of the alert event and the alert control conditions.

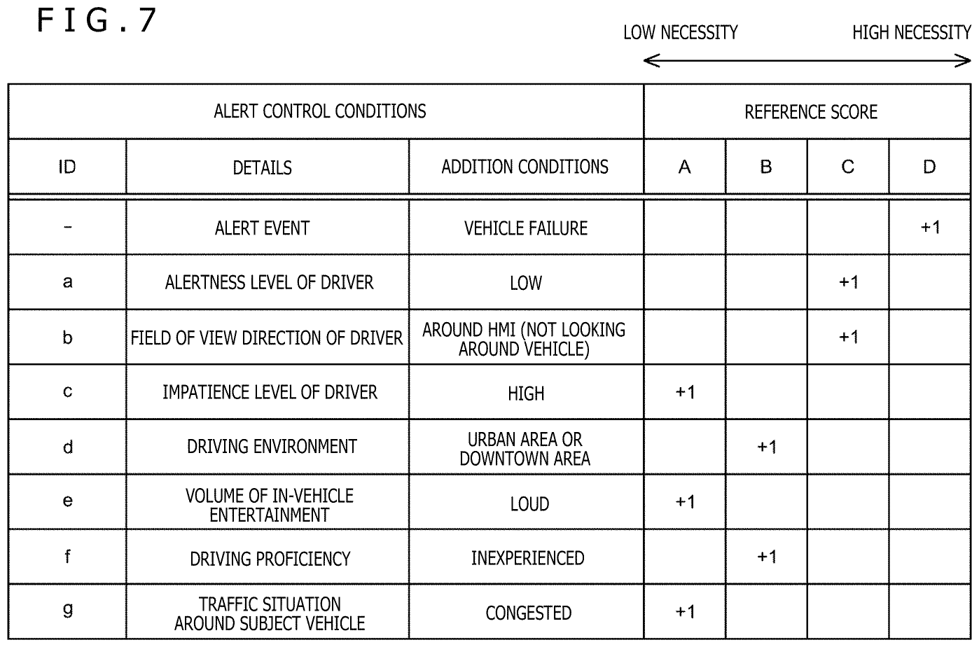

Here, with reference to FIG. 7, a specific example of a calculation method for reference scores is described. FIG. 7 is a table illustrating a calculation method for reference scores.

In this example, the reference score is classified into four levels of rank from a score A to a score D according to the necessity of alerts. The later the letter in the alphabet, the higher the rank. That is, the reference score D has the highest rank, and the reference score A has the lowest rank. In other words, the reference score D indicates the highest necessity of alerts, while the reference score A indicates the lowest necessity of alerts.

In this example, for each of an alert control condition “a” to an alert control condition “g,” the necessity of alerts is estimated, and the reference score A to the reference score C are assigned depending on the estimated necessity of alerts. That is, for example, an alert control condition assigned with the reference score A is estimated as a condition with a low necessity of alerts. For example, an alert control condition assigned with the reference score B is estimated as a condition with the moderate necessity of alerts. For example, an alert control condition assigned with the reference score C is estimated as a condition with a high necessity of alerts.

Note that it is estimated that conditions with a high necessity of alerts are highly likely to be conditions with high urgency under which it is necessary to urgently output alerts. On the other hand, it is estimated that conditions with a low necessity of alerts are highly likely to be conditions with a low urgency of alerts.

The alert control condition “a” relates to the alertness level of the driver and is assigned with the reference score C. Besides, in a case where the alertness level of the driver is low, for example, in a case where the alertness level of the driver is equal to or lower than a predetermined level, +1 is added to the value of the reference score C.

The alert control condition “b” relates to the field of view direction of the driver and is assigned with the reference score C. Besides, in a case where the driver is looking around the HMI (for example, around the center display in FIG. 4) inside the vehicle, that is, in a case where the driver is not looking around the vehicle 1, +1 is added to the value of the reference score C.

The alert control condition “c” relates to the impatience level of the driver and is assigned with the reference score A. Besides, in a case where the impatience level of the driver is high (in a case where the driver is being impatient), +1 is added to the value of the reference score A. For example, in a case where the average speed of the vehicle 1 is faster than the normal average speed by the driver during driving by a predetermined value or more, or in a case where the estimated arrival time at the destination is delayed by a predetermined time or more from the desired arrival time, it is determined that the impatience level of the driver is high.

The alert control condition “d” relates to the driving environment of the vehicle 1 and is assigned with the reference score B. In a case where the driving environment is an urban area or a downtown area, +1 is added to the value of the reference score B.

The alert control condition “e” relates to the volume of in-vehicle entertainment and is assigned with the reference score A. In-vehicle entertainment refers to audio, video, games, and the like executed inside the vehicle 1. In a case where the volume of in-vehicle entertainment is loud, for example, in a case where the volume of in-vehicle entertainment is equal to or higher than a predetermined threshold, +1 is added to the value of the reference score A.

The alert control condition “f” relates to the driving proficiency of the driver and is assigned with the reference score B. In a case where the driving proficiency is inexperienced, for example, in a case where the driving experience of the driver is less than a predetermined number of years, +1 is added to the value of reference score B.

The alert control condition “g” relates to the traffic situation around the subject vehicle and is assigned with the reference score A. In a case where the area around the subject vehicle is congested, for example, in a case where the density of vehicles around the vehicle 1 is equal to or higher than a predetermined threshold, +1 is added to the reference score A.

In this manner, the reference score is calculated on the basis of the alert control conditions, thereby estimating the necessity of the alert in the current situation of the vehicle 1.

Note that, irrespective of the alert control conditions, the highest-ranking reference score D is assigned to predetermined alert events. In the case of this example, in a case where the alert event is a vehicle failure, +1 is added to the value of the reference score D.

That is, in a case where a vehicle failure has occurred, the necessity of the alert is estimated to be very high regardless of the alert control conditions.

The score calculation unit 161 notifies the level setting unit 162 of the calculated reference score.

In Step S4, the level setting unit 162 sets the output level of the alert on the basis of the reference score.

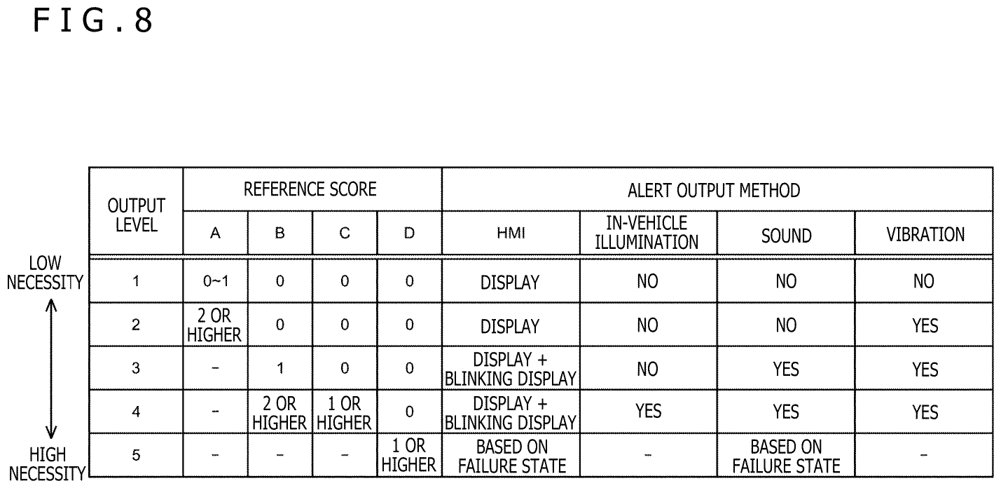

FIG. 8 is a table illustrating examples of a relation between the reference score, the output level, and the output method for alerts. Note that, in FIG. 8, cells with “-” in the reference score indicate that the output level is set regardless of the score in that cell.

The output level of an alert is set on the basis of a reference score. Since the reference score is calculated on the basis of the necessity of the alert, essentially, the output level of the alert is set on the basis of the necessity of the alert.

The output level of alerts is classified into five levels from a level 1 to a level 5, with larger numerical values indicating higher levels. That is, the output level 5 is the highest level, and the output level 1 is the lowest level.

For example, in a case where the values of the reference score B to the reference score D are 0 and the value of the reference score A is 0 or 1, the output level is set to the level 1.

For example, in a case where the values of the reference score B to the reference score D are 0 and the value of the reference score A is 2 or higher, the output level is set to the level 2.

For example, in a case where the values of the reference score C and the reference score D are 0 and the value of the reference score B is 1, the output level is set to the level 3.

For example, in a case where the values of the reference score C and the reference score D are 0 and the value of the reference score B is 2 or higher, or in a case where the value of the reference score D is 0 and the value of the reference score C is 1 or higher, the output level is set to the level 4.

For example, in a case where the reference score D is 1 or higher, the output level is set to the level 5.

Therefore, in a case where the alert event is other than a vehicle failure, the output level is set to one of the level 1 to the level 4 on the basis of the alert control condition “a” to the alert control condition “g” in FIG. 7, regardless of the type of the alert event.

On the other hand, in a case where the alert event is a vehicle failure, the output level is unconditionally set to the level 5 regardless of the alert control conditions.

The level setting unit 162 notifies the output control unit 152 of the set output level.

In Step S5, the vehicle 1 outputs the alert. Specifically, under the control of the output control unit 152, the alert output unit 144 outputs the alert for the alert event detected by the alert event detection unit 141, using the output method corresponding to the output level set by the level setting unit 162.

For example, as illustrated in FIG. 8, the alert is output by a combination of one or more of the four types of output methods: “HMI,” “in-vehicle illumination,” “sound,” and “vibration.”

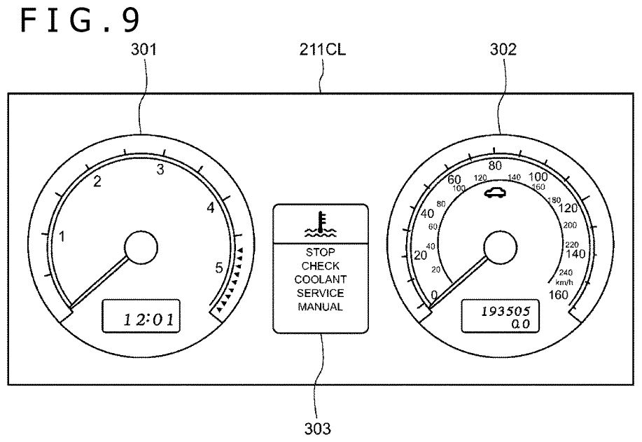

FIG. 9 illustrates an example of an output method using “HMI.” Specifically, FIG. 9 illustrates an example of the display content of the display unit 211CL of the central part 211C of the center display 211 in FIG. 4.

In the display unit 211CL, an analog tachometer 301 and an analog speedometer 302 are displayed side by side. Further, a warning display 303 is displayed between the tachometer 301 and the speedometer 302.

The warning display 303 displays marks and messages indicating warning content. Further, the warning display 303 changes in color or blinks as needed.

Besides, “HMI” is an output method for displaying or blinking the warning display 303.

“In-vehicle illumination” is an output method for turning on the loop light 231 in FIG. 5, for example.

“Sound” is an output method for outputting warning sounds or warning messages from a speaker, which is not illustrated, for example.

“Vibration” is an output method for vibrating the steering wheel 203 in FIG. 4, for example.

At the output level 1, for example, alerts are output only by the display of “HMI.”

At the output level 2, for example, alerts are output by the display of “HMI” and “vibration.”

At the output level 3, for example, alerts are output by the blinking display of “HMI,” “sound,” and “vibration.”

At the output level 4, for example, alerts are output by the blinking display of “HMI,” “in-vehicle illumination,” “sound,” and “vibration.”

In this manner, as the output level is increased from the level 1 to the level 4, the types of output methods for alerts are increased. Further, “HMI” is not only displayed but also blinks.

Therefore, as the output level is increased, the recognizability of alerts is increased. For example, as the output level is increased, it becomes easier for the occupant of the vehicle 1 to notice alerts or recognize the content of the alerts.

At the output level 5, alerts are output by “HMI” and “sound.” The output method using “HMI” and “sound” is based on failure states. At the output level 5, the recognizability of alerts is even higher. For example, the occupant of the vehicle 1 becomes able to notice alerts quickly and easily, or easily recognize the failure states.

After that, the processing returns to Step S2, and the processing after Step S2 is executed.

In the manner as described above, the effectiveness of alerts of the vehicle 1 is improved.

For example, for the same alert event, the output level is appropriately controlled on the basis of the alert control conditions, according to the necessity of the alert.

That is, even if the same alert event occurs, the higher the necessity of the alert, the higher the output level of the alert becomes. As a result, the recognizability of the alert for the alert event is increased, and the alert event becomes easier to recognize. In contrast, even if the same alert event occurs, the lower the necessity of the alert, the lower the output level of the alert becomes. As a result, the annoyance toward the alert is reduced.

For example, in a case where the alertness level of the driver is low, for the same alert event, the necessity of the alert is high compared to a case where the alertness level of the driver is high, due to a decreased ability of the driver to recognize the alert event. Besides, in a case where the alertness level of the driver is low, the output level of the alert is high compared to a case where the alertness level of the driver is high.

With this, the driver can quickly recognize alert events even in a case where the alertness level is low. On the other hand, in a case where the alertness level of the driver is high, the output levels of alerts are low, thereby preventing the driver from finding the alerts annoying.

As a result, for example, the trust of the occupant in alerts is increased, and the message effectiveness of more urgent alerts is improved. Further, for example, an unnecessary hindrance to the driving or riding experience of the occupant is prevented, thereby allowing the occupant to concentrate on driving or riding experience.

Further, except for a case where the output level is the level 5, the output method for alerts is common for each output level regardless of the types of alert events. With this, for example, the complication of alerts due to the high functionalization of the vehicle 1 is prevented, and the design of alerts is thus simplified. Further, the recognizability of alerts is increased, thereby allowing the occupant to easily identify the reasons why the alerts have been output, for example. Moreover, for example, the flexibility of the alert function of the vehicle 1 is improved. For example, it becomes possible to easily add alerts in a case where the functions of the vehicle 1 are updated by OTA (Over The Air) or the like and the types of alerts are increased.

### 3. Modified Examples

Modified examples of the embodiment of the present technology described above are described.

For example, the number of ranks of the reference score can be changed as appropriate.

For example, the number of levels of the output level can be changed as appropriate.

For example, the alert event is not particularly limited and can be changed as appropriate.

For example, as long as the alert control conditions are conditions independent of alert events, in other words, as long as the alert control conditions are conditions different from alert events, the alert control conditions are not limited to the examples described above and can be changed as appropriate. For example, it is possible to use the situation inside the vehicle, such as the number of occupants and the states of occupants (for example, sleeping, conversing, or conversation is lively), as alert control conditions. For example, it is possible to use states other than the volume of in-vehicle entertainment (for example, types or content of contents) as alert control conditions.

For example, a relation between the alert control conditions and the reference score, in other words, the relation between the alert control conditions and the necessity of alerts, may be updated as appropriate by performing machine learning using a cloud system or the like. With this, the alert control conditions and the reference score are set more appropriately. Further, for example, using machine learning, the relation between the alert control conditions and the necessity of alerts may be personalized for each user.

For example, the types of vehicles to which the present technology can be applied are not particularly limited.

The present technology can also be applied to a case where alerts are output in mobile bodies other than vehicles, for example.

For example, the alert processing unit 131 in FIG. 3 does not necessarily need to be installed in a mobile body such as the vehicle 1, but may be provided in an information processing apparatus such as a smartphone that is brought into the mobile body.

The present technology can also be applied to a case where alerts are output to users carrying portable information terminals such as smartphones, for example. For example, the present technology can also be applied to a case where alerts are output to users walking while looking at their smartphones.

### 4. Others

### Configuration Example of Computer

The series of processing processes described above can be executed by hardware or software. In a case where the series of processing processes is executed by software, a program configuring that software is installed on a computer. Here, examples of the computer include computers incorporated in dedicated hardware and, for example, general-purpose personal computers capable of executing various functions with various programs installed thereon.

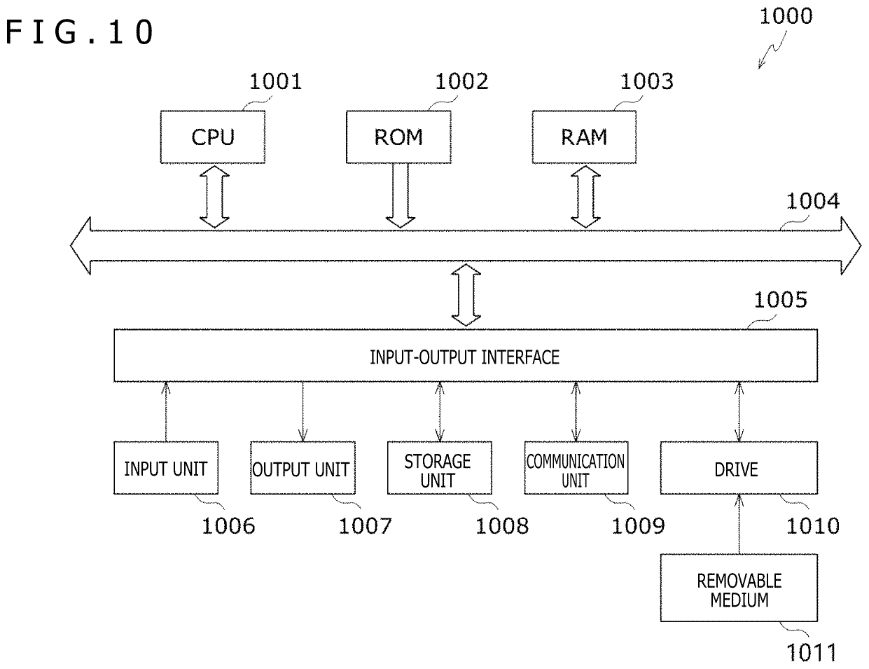

FIG. 10 is a block diagram illustrating a configuration example of the hardware of a computer configured to execute the series of processing processes described above by the program.

In a computer 1000, a CPU (Central Processing Unit) 1001, a ROM (Read Only Memory) 1002, and a RAM (Random Access Memory) 1003 are connected to each other through a bus 1004.

An input-output interface 1005 is further connected to the bus 1004. The input-output interface 1005 is connected to an input unit 1006, an output unit 1007, a storage unit 1008, a communication unit 1009, and a drive 1010.

The input unit 1006 includes an input switch, a button, a microphone, an imaging element, or the like. The output unit 1007 includes a display, a speaker, or the like. The storage unit 1008 includes a hard disk, a non-volatile memory, or the like. The communication unit 1009 includes a network interface or the like. The drive 1010 drives a removable medium 1011 such as a magnetic disk, an optical disc, a magneto-optical disk, or a semiconductor memory.

In the computer 1000 configured as described above, for example, the CPU 1001 loads the program recorded on the storage unit 1008 into the RAM 1003 through the input-output interface 1005 and the bus 1004 and executes the program to perform the series of processing processes described above.

The program that the computer 1000 (CPU 1001) executes can be recorded on the removable medium 1011, which serves as a package medium or the like, to be provided, for example. Further, the program can be provided via a wired or wireless transmission medium such as a local area network, the Internet, or digital satellite broadcasting.

In the computer 1000, the program can be installed on the storage unit 1008 through the input-output interface 1005 with the removable medium 1011 mounted on the drive 1010. Further, the program can be received by the communication unit 1009 via a wired or wireless transmission medium to be installed on the storage unit 1008. In addition, the program can be installed on the ROM 1002 or the storage unit 1008 in advance.

Note that the program that the computer executes may be a program whose processing processes are performed chronologically in the order described herein or in parallel. Alternatively, the program may be a program whose processing processes are performed at necessary timing such as when the program is called.

Further, the “system” herein means a set of multiple components (apparatuses, modules (parts), or the like), and it does not matter whether all the components are in the same housing or not. Therefore, multiple apparatuses accommodated in separate housings and connected to each other via a network, and a single apparatus including multiple modules accommodated in a single housing, are both systems.

Moreover, embodiments of the present technology are not limited to the embodiment described above, and various modifications can be made without departing from the gist of the present technology.

For example, the present technology can employ the configuration of cloud computing in which a single function is shared and collaboratively processed by multiple apparatuses via a network.

Further, each step described using the flowchart described above can be executed by a single apparatus or can be shared and executed by multiple apparatuses.

Moreover, in a case where multiple processing processes are included in a single step, the multiple processing processes included in the single step can be executed by a single apparatus or can be shared and executed by multiple apparatuses.

### Examples of Combinations of Configurations

The present technology can also take the following configurations.

(1)

An information processing apparatus including:
an alert event detection unit configured to detect an alert event that includes an event for which an alert is output;
an alert control condition detection unit configured to detect an alert control condition that includes a condition for controlling an output method for the alert; and
an alert control unit configured to control the output method for the alert for the alert event on the basis of the alert control condition.
   (2)

The information processing apparatus according to (1) above, in which the alert control unit sets an output level of the alert on the basis of the alert control condition, and controls the output method for the alert on the basis of the output level.

(3)

The information processing apparatus according to (2) above, in which the alert control unit controls the output method for the alert such that, as the output level is increased, recognizability of the alert is increased.

(4)

The information processing apparatus according to (3) above, in which the alert control unit estimates a necessity of the alert on the basis of the alert control condition, and sets the output level higher as the necessity of the alert is increased.

(5)

The information processing apparatus according to (3) to (4) above, in which the alert control unit increases the number of types of the output method for the alert as the output level is increased.

(6)

The information processing apparatus according to any one of (2) to (5) above, in which the alert control unit performs control such that the alert is output by a common output method for each of the output levels regardless of a type of the alert event.

(7)

The information processing apparatus according to any one of (1) to (6) above, in which the alert control unit controls the output method for the alert for the alert event on the basis of the alert control condition regardless of a type of the alert event.

(8)

The information processing apparatus according to (7) above, in which, in a case where a predetermined type of the alert event is detected, the alert control unit causes the alert to be output by an output method corresponding to the alert event regardless of the alert control condition.

(9)

The information processing apparatus according to any one of (1) to (8) above, in which the alert control unit estimates a necessity of the alert on the basis of the alert control condition, and controls the output method for the alert on the basis of the necessity of the alert.

(10)

The information processing apparatus according to any one of (1) to (9) above, in which the alert control condition includes a condition independent of the alert event.

(11)

The information processing apparatus according to any one of (1) to (10) above, further including: an alert output unit configured to output the alert.

(12)

The information processing apparatus according to (11) above, in which the alert output unit outputs the alert using at least one or more of visual information, auditory information, and tactile information.

(13)

The information processing apparatus according to any one of (1) to (12) above, in which the alert includes an alert of a mobile body.

(14)

The information processing apparatus according to (13) above, in which the alert control condition detection unit detects the alert control condition on the basis of at least one of a situation around the mobile body, a situation inside the mobile body, a state of the mobile body, and a state of an occupant of the mobile body.

(15)

The information processing apparatus according to (13) or (14) above, in which the alert event detection unit detects the alert event on the basis of at least one of a situation around the mobile body, a situation inside the mobile body, a state of the mobile body, and a state of an occupant of the mobile body.

(16)

The information processing apparatus according to any one of (13) to (15) above, in which the mobile body includes a vehicle.

(17)

The information processing apparatus according to any one of (1) to (12) above, in which the alert includes an alert of a portable information terminal.

(18)

An information processing method, including:
by an information processing apparatus,
detecting an alert event that includes an event for which an alert is output;
detecting an alert control condition that includes a condition for controlling an output method for the alert; and
controlling the output method for the alert for the alert event on the basis of the alert control condition.
   (19)

A program for causing a computer to execute processing of:
detecting an alert event that includes an event for which an alert is output;
detecting an alert control condition that includes a condition for controlling an output method for the alert; and
controlling the output method for the alert for the alert event on the basis of the alert control condition.

Note that the effects described herein are merely exemplary and not limiting, and there may be other effects.

### REFERENCE SIGNS LIST

1: Vehicle
11: Vehicle control system
131: Alert processing unit
141: Alert event detection unit
142: Alert control condition detection unit
143: Alert control unit
144: Alert output unit
151: Output level control unit
152: Output control unit
161: Score calculation unit
162: Level setting unit
171: Visual information output unit
172: Auditory information output unit
173: Tactile information output unit

1. An information processing apparatus comprising:
an alert event detection unit configured to detect an alert event that includes an event for which an alert is output;
an alert control condition detection unit configured to detect an alert control condition that includes a condition for controlling an output method for the alert; and
an alert control unit configured to control the output method for the alert for the alert event on a basis of the alert control condition.

2. The information processing apparatus according to claim 1, wherein the alert control unit sets an output level of the alert on the basis of the alert control condition, and controls the output method for the alert on a basis of the output level.

3. The information processing apparatus according to claim 2, wherein the alert control unit controls the output method for the alert such that, as the output level is increased, recognizability of the alert is increased.

4. The information processing apparatus according to claim 3, wherein the alert control unit estimates a necessity of the alert on the basis of the alert control condition, and sets the output level higher as the necessity of the alert is increased.

5. The information processing apparatus according to claim 3, wherein the alert control unit increases the number of types of the output method for the alert as the output level is increased.

6. The information processing apparatus according to claim 2, wherein the alert control unit performs control such that the alert is output by a common output method for each of the output levels regardless of a type of the alert event.

7. The information processing apparatus according to claim 1, wherein the alert control unit controls the output method for the alert for the alert event on the basis of the alert control condition regardless of a type of the alert event.

8. The information processing apparatus according to claim 7, wherein, in a case where a predetermined type of the alert event is detected, the alert control unit causes the alert to be output by an output method corresponding to the alert event regardless of the alert control condition.

9. The information processing apparatus according to claim 1, wherein the alert control unit estimates a necessity of the alert on the basis of the alert control condition, and controls the output method for the alert on a basis of the necessity of the alert.

10. The information processing apparatus according to claim 1, wherein the alert control condition includes a condition independent of the alert event.

11. The information processing apparatus according to claim 1, further comprising:
an alert output unit configured to output the alert.

12. The information processing apparatus according to claim 11, wherein the alert output unit outputs the alert using at least one or more of visual information, auditory information, and tactile information.

13. The information processing apparatus according to claim 1, wherein the alert includes an alert of a mobile body.

14. The information processing apparatus according to claim 13, wherein the alert control condition detection unit detects the alert control condition on a basis of at least one of a situation around the mobile body, a situation inside the mobile body, a state of the mobile body, and a state of an occupant of the mobile body.

15. The information processing apparatus according to claim 13, wherein the alert event detection unit detects the alert event on a basis of at least one of a situation around the mobile body, a situation inside the mobile body, a state of the mobile body, and a state of an occupant of the mobile body.

16. The information processing apparatus according to claim 13, wherein the mobile body includes a vehicle.

17. The information processing apparatus according to claim 1, wherein the alert includes an alert of a portable information terminal.

18. An information processing method comprising:
by an information processing apparatus,
detecting an alert event that includes an event for which an alert is output;
detecting an alert control condition that includes a condition for controlling an output method for the alert; and
controlling the output method for the alert for the alert event on a basis of the alert control condition.

19. A program for causing a computer to execute processing of:
detecting an alert event that includes an event for which an alert is output;
detecting an alert control condition that includes a condition for controlling an output method for the alert; and
controlling the output method for the alert for the alert event on a basis of the alert control condition.
